(19) United States
(12) Patent Application Publication
(10) Pub. No.: US 2013/0139404 A1
(43) Pub. Date: Jun. 6, 2013

(54) TUMBLE DRYER HAVING A FIRE EXTINGUISHING SYSTEM

(71) Applicant: BSH Bosch und Siemens Hausgarate GmbH, Munich (DE)

(72) Inventor: Gerhard Stegerwald, Virginia Beach, VA (US)

(73) Assignee: BSH Bosch und Siemens Hausgarate GmbH, Munich (DE)

(21) Appl. No.: 13/680,170

(22) Filed: Nov. 19, 2012

(30) Foreign Application Priority Data
Dec. 1, 2011 (DE) 10 2011 087 607.3

(51) Int. Cl. F26B 20/00

(52) U.S. Cl. CPC F26B 20/00
USPC 34/524

(57) ABSTRACT

A tumble dryer includes a drum which has an interior for holding laundry items, and at least one container which is received in the interior of the drum. The container has a cavity which is filled with an extinguishing medium. At least one release device is arranged in a cavity wall of the container for the extinguishing medium and is activated in the event of a fire starting or having started in the drum to thereby provide an opening to the cavity of the container.

### BACKGROUND OF THE INVENTION

The invention relates to a tumble dryer, in particular a domestic tumble dryer having a fire extinguishing device.

Generally known tumble dryers have as a general rule a cylindrical drum for holding the laundry, which drum is arranged in rotatable fashion around a horizontal axis. In this situation a warm air current is normally fed in or out by way of the end walls of the drum. It is also known to provide paddles in the drum of tumble dryers in order to set the laundry in motion when the drum is rotating and to achieve a better warm air flow through the laundry.

The problem is furthermore known that a fire may occur in the event of overheating in rare exceptional cases. In particular when drying textiles having a very high and fine lint content, or in the case of a blockage in an air channel, a fire cannot be completely ruled out. Accordingly, high demands are placed on tumble dryers in order to design them such that any possible fire is not able to escape from the drum to the other components of the tumble dryer or even to the surroundings of the tumble dryer.

In some countries, corresponding testing methods are already in force or should come into force in the near future in order to demonstrate that a fire thus started remains in the machine and does not spread outside it. For example, in the USA with effect from 2013 tumble dryers must pass the test required by UL 2158 (Fire Containment). In this situation, a cloth placed over the tumble dryer must not ignite during the test. Should the cloth ignite, the test is considered to have been failed and the machines may not be sold on the US market.

The manufacturers of tumble dryers therefore endeavor to offer tumble dryers in which the fire can be extinguished in the interior of the tumble dryer, or in which it is at least possible to prevent the fire escaping to the outside.

DE 10 2007 061 521 A1 relates to a tumble drying machine which is equipped with a fire extinguishing device. This tumble drying machine has a fire detector, an extinguishing medium supply device for introducing an extinguishing medium into the tumble drying machine, in particular into the drum, and an electronic control unit. In this situation, the fire detector is preferably an electronic temperature sensor which for example can be arranged in the collar or on the base of the drum housing. As soon as the fire detector receives a temperature or smoke signal, the control unit triggers an extinguishing function by means of which the fire extinguishing medium which is stored outside the drum is transported to the drum with the aid of an electrically operated pump and sprayed into the drum.

The U.S. Pat. No. 6,725,570 describes a fire protection system for tumble dryers, in which the temperature inside the drying chamber is monitored and a determination is made by an electronic controller as to whether or not a fire exists in the dryer. The extinguishing medium is introduced into the drum by way of a pipe and a nozzle.

EP 2 360 310 A1 shows a container in a drying chamber of a dryer, from which extinguishing agent can be deployed by way of nozzles by means of a propellant.

DE 38 09 754 A1 shows a multiplicity of containers arranged beside one another, which can be arranged inside a domestic appliance, and extinguishing agent can be deployed from the containers by way of holes by means of a propellant when a foil or film or casing melts and uncovers the holes.

DE 10 2007 061 521 A1 shows an extinguishing agent delivery device for a drying chamber of a dryer, by way of which an extinguishing agent provided outside the drum can be introduced into the drum by means of a propellant.

Consequently, appliances are known from the prior art in which the extinguishing medium is accommodated outside the drum and only needs to be introduced into the drum in the event of a possible fire. In addition, both the fire protection system and also the fire extinguishing device are dependent on the power supply of the domestic appliance.

JP 09 056 996 A shows a drying chamber of a dryer, in which a container holding extinguishing agent can melt completely when a fire occurs. The extinguishing agent can be provided in a separate container or between two walls of the drying chamber. A fire must melt the container or the inner wall in order to allow the extinguishing agent to be released.

### BRIEF SUMMARY OF THE INVENTION

An object of the invention is therefore to provide a tumble dryer having a fire extinguishing device in the drum, which represents a simple but nevertheless safe construction for extinguishing a fire and still continues to function even if the fire has already interrupted the power supply of the domestic appliance.

This object is achieved by a tumble dryer as claimed in claim 1. Advantageous embodiments are set down in the dependent claims.

The tumble dryer of the present invention has a cylindrical drum, the drum being equipped in its interior with at least one, preferably two or more, containers. In one embodiment, the drum consists of enameled sheet metal, stainless steel or plastic.

The tumble dryer according to the invention is characterized in that at least one of the containers has a cavity filled with an extinguishing medium and at least one release device for the extinguishing medium, the release device being designed so that it is activated in the event of a fire starting or having started in the drum, with the result that an opening to the cavity of the container is produced. The container is arranged either on the radial internal wall of the drum or on at least one of the two end walls of the drum. The container is for example a drum paddle or even a component which has no paddle function. This component is for example a thin circular annular shaped or circular annular segment shaped cavity body which is fitted on the radial internal wall of the drum or one of the two end walls. In one embodiment, in addition to the drum paddles filled with extinguishing medium at least one component can be arranged in the interior of the drum. In a preferred embodiment, the component(s) is/are not arranged over the entire length of the drum so as to avoid an unnecessary loss of space in the interior of the drum. By preference, they are however distributed evenly over the circumference of the drum in order to avoid imbalance.

By preference, the container is a drum paddle. A drum paddle is understood to be a rib, bar or bulge on the inner side of the cylindrical drum, which agitates the laundry when the drum is rotating. The drum preferably has two or more drum paddles, three for example.

The advantages which can be achieved with the invention are seen to consist in the fact that the tumble dryer is protected with a high level of confidence against the danger of a fire because in the event of a fire in the drum a fire extinguishing device is activated, the extinguishing medium for which is located directly in the drum and does not need to be first pumped into the drum. Since the present invention is concerned with a purely mechanical solution, it is independent of the power supply for the domestic appliance, and furthermore particularly cost-effective. The tumble dryer is therefore designed so as to release extinguishing medium without propellant in the drum.

As a result of introducing an extinguishing medium the fire is extinguished more quickly than in comparison with an uninfluenced fire in the drum interior. By this means, the risk of the fire spreading or of the fire escaping from the drum is reduced.

According to an advantageous development of the invention, the tumble dryer is also characterized in that at least one of the containers is a hollow body, whereby the containers can be formed as an integral part into the drum or can be inserted as an additional component into the drum. The containers can be constructed and shaped in many different ways, in particular in the embodiment as drum paddles they can be shaped symmetrically or asymmetrically as a rib, bulge or bar. The containers are as a rule oriented parallel to the rotational axis of the drum, but a helical shaping on the inside of the drum is also conceivable. In a preferred embodiment, the containers are drum paddles which have a symmetrical V-shaped basic profile with a tip of the V-profile (paddle corner piece) facing the drum interior and also two edges (side walls).

The containers can be manufactured from plastic or metal.

At least one of the containers designed as a hollow body has at least one release device. By preference however, it has a plurality of release devices. The release device(s) serves/serve as a “predetermined breaking point” in the cavity wall and melt first under the influence of heat, in other words they melt before the surrounding cavity wall of the container. The release device is therefore melted open in the case of a fire starting or having started in the drum, with the result that an opening to the cavity of the container is produced and the extinguishing medium enters the drum and is thus able to extinguish the fire which is starting or has started. Since the fire in the drum can easily reach temperatures of 500° C. to 800° C. and higher, it is sufficient if the predetermined breaking points already melt below this temperature range, for example at temperatures above 150° C., preferably at 200° C. to 450° C. The release device is therefore a purely mechanical device and independent of the power supply of the tumble dryer.

The release device(s) preferably consists/consist of thin-walled plastic which is incorporated like a window into the cavity wall or is formed in the cavity wall and melts under the influence of heat. This results in at least one opening from the cavity of the container to the drum, by means of which the extinguishing medium is released. By preference, polypropylene is used as the plastic for the release device, for example a less fire-resistant polypropylene which already melts at relatively low temperatures. A fire-resistant polypropylene can then be used for the remainder of the cavity wall. By preference however, the cavity wall and the release devices arranged therein consist of the same material which already melts when a fire is starting.

The release device(s) is/are designed for example as circular, punctiform, square, elongated or slot-like in form. By preference, said release devices are arranged over the entire length of the container, in other words as a rule in the axial direction of the drying chamber. This means that an even release of the extinguishing medium is made possible over the entire length of the drum. In the case of a large number of small punctiform or square shaped release devices the extinguishing medium is released in spray-like fashion.

In a preferred embodiment, the container is a V-shaped drum paddle which has release devices arranged on the two side walls. Alternatively or additionally, the release device(s) can also be arranged on the paddle corner piece in the V-shaped drum paddle.

In one embodiment, the release devices occupy only small surface areas of the container. In another embodiment, the container has only a single or a few large-area release device(s) which is/are designed as elongated or slot-like. In a preferred embodiment, the container is a V-shaped drum paddle and a large-area release device is situated on the paddle corner piece. Such large-area release devices enable a flood-like release of the extinguishing medium. Both the small and also the large-area release devices should be designed such that the cavity of the container can largely empty through the opened release device(s), in other words that the extinguishing medium is released almost completely.

In one embodiment, at least one of the containers has a cavity and a plurality of release devices. In another embodiment, at least one of the containers has a plurality of cavities and a plurality of release devices, at least one release device being assigned to each cavity. By particular preference, two or three containers have a cavity and at least one release device.

In one embodiment, the container and thus the cavity walls are made of metal and the release device(s) of plastic, for example a plastic film stretched across corresponding holes in the cavity wall. In another embodiment, the container and the release devices are made of different plastics. By preference, both the container and also the release device(s) are made of the same plastic and differ only in the wall thickness, in other words the release device(s) is/are a sectionwise thinning of the material in the cavity wall of the container. In a particularly preferred embodiment, the wall thickness of the release device is approximately half the wall thickness of the container. For example, the container has a wall thickness of 2 to 3 mm and the release devices thus a thickness of 0.2 to 2 mm, preferably 1 to 1.5 mm.

The cavity or the cavities of the container are filled with an extinguishing medium. The extinguishing medium can be both a liquid and also a fluid or powder. By preference, the extinguishing medium is an extinguishing powder or water.

The cavity or the cavities of the container are designed such that they are filled almost completely with the extinguishing medium. The cavity of the containers is preferably not completely filled if the extinguishing medium, such as water for example, expands greatly at the normal operating temperatures of the dryer. By preference, at least half a liter of liquid or powder or fluid can be present in the cavity of the container. In a preferred embodiment, the tumble dryer according to the invention has three paddles, each of which has a cavity containing approximately half a liter of extinguishing medium.

### BRIEF DESCRIPTION OF THE DRAWINGS

Further advantages, features and characteristics of the invention will emerge from the following description of advantageous embodiments with reference to the figures in the attached drawing. In the drawings:

FIG. 1 shows a cross-section through an embodiment of the tumble dryer;

FIG. 2 shows a cross-section through another embodiment of the tumble dryer;

FIG. 3 shows a cross-section through a drum paddle of another embodiment of the tumble dryer;

FIG. 4 shows a perspective view of a drum in accordance with another embodiment of the tumble dryer with a paddle illustrated in cut-away fashion;

FIG. 5 shows a cross-section through the tumble dryer shown in FIG. 2 with opened release devices;

FIG. 6 shows a cross-section through the tumble dryer shown in FIG. 2 with opened release devices and emptied paddles;

FIG. 7 shows a perspective view of a drum in accordance with another embodiment of the tumble dryer.

### DETAILED DESCRIPTION OF EXEMPLARY EMBODIMENTS OF THE PRESENT INVENTION

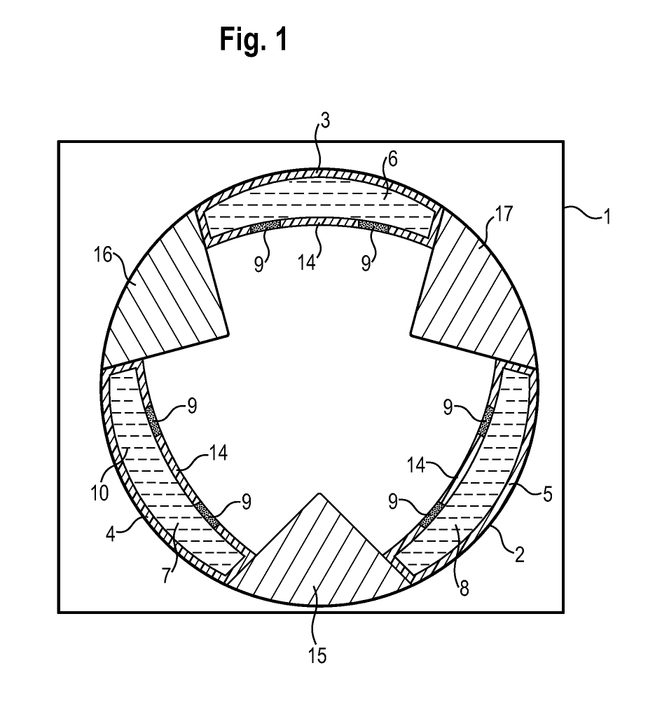

FIG. 1 schematically shows a cross-section through a drum of a tumble dryer 1, wherein the drum 2 can rotate around a horizontal axis and the containers 3, 4, 5 are mounted on the internal walls of the drum. In this embodiment the containers are components having no paddle function and are mounted directly on the internal wall of the drum. In addition, on its internal wall the drum has the paddles 15, 16 and 17 for agitating the laundry while the drum is moving. In this embodiment the paddles 15, 16, 17 have a V-shaped profile. The containers each have a thin circular annular segment shaped profile. Each of the containers has at least one cavity 6, 7, 8 and also a plurality of release devices 9 in the walls 14 which face the interior of the drum. In this embodiment the release devices 9 are represented as elongated slots. The entire cavity of the containers is filled with water or extinguishing powder 10. The containers 3, 4, 5 and the release devices 9 are produced from different plastic materials, wherein the plastic of the release devices 9 melts under the influence of heat before the plastic material of the cavity wall surrounding them of the containers. In the event of a fire in the drum the material of the release device melts, which causes the release devices to open and the water or extinguishing powder 10 can enter the drum.

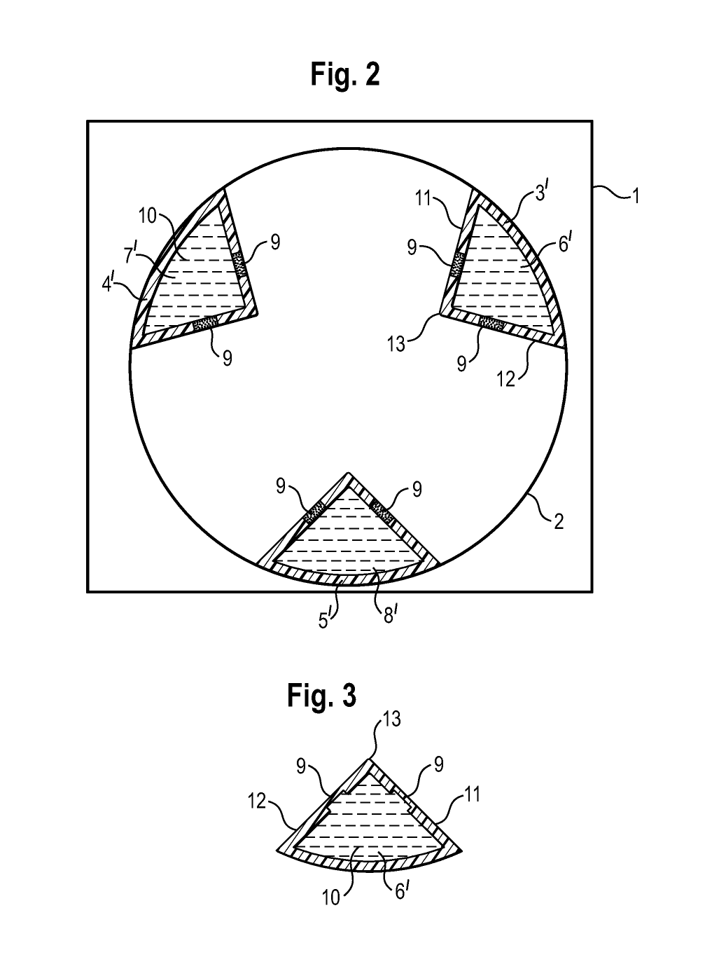

FIG. 2 schematically shows a cross-section through a drum of another embodiment of the tumble dryer 1, wherein the containers which are arranged on the internal walls of the drum are designed as drum paddles 3′, 4′, 5′ for agitating the laundry while the drum is moving. The drum paddles 3′, 4′, 5′ have a V-shaped profile, each having two side walls 11, 12 and a corner piece 13. Each of the drum paddles has at least one cavity 6′, 7′, 8′ and also a plurality of release devices 9 in the side walls 11, 12. In this embodiment the release devices 9 are also represented as elongated slots. The entire cavity of the drum paddles is filled with water or extinguishing powder 10. The drum paddles 3′, 4′, 5′ and the release devices 9 are produced from different plastic materials, wherein the plastic of the release devices 9 melts under the influence of heat before the plastic material of the cavity wall surrounding them of the drum paddles. In the event of a fire in the drum the material of the release device melts, which causes the release devices to open and the water or extinguishing powder 10 can enter the drum.

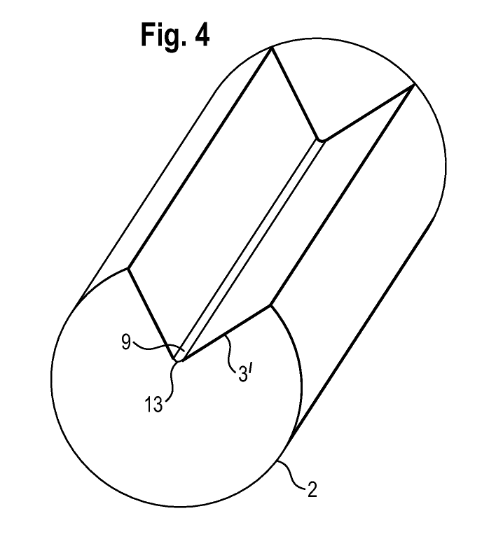

FIG. 3 schematically shows a drum paddle in accordance with another embodiment of the tumble dryer. This drum paddle also has a V-shaped profile having two side walls 11, 12 and a corner piece 13. The extinguishing medium 10 is situated in the cavity 6′ of the paddle. The release devices 9 are designed here as thin-walled sections in the cavity wall of the paddle and thus consist of the same plastic material as the drum paddle.

FIG. 4 shows a perspective view of a drum 2 in accordance with another embodiment, which for the sake of clarity contains only one paddle 3′. This paddle 3′ illustrated in cut-away fashion likewise has a cavity and a release device 9 which takes the form of an elongated thinning of the material along the paddle corner piece 13. The release device 9 thus essentially extends over the entire length of the paddle.

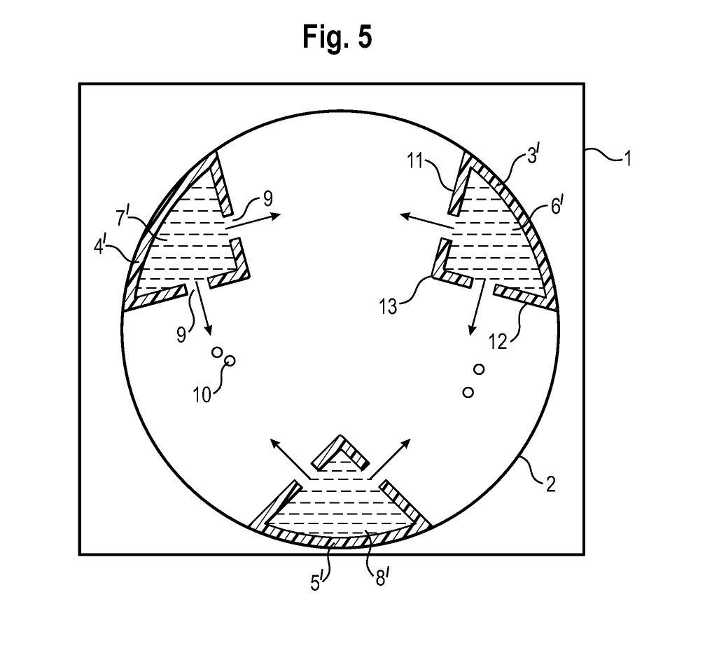

FIG. 5 shows the embodiment from FIG. 2, wherein the release devices 9 have been melted by a fire having started and thus a plurality of openings to the cavity of the respective paddle 3′, 4′, 5′ has been produced. Consequently, the extinguishing medium 10 contained in the cavity 6′, 7′, 8′ of the paddles 3′, 4′, 5′ flows out (in the direction indicated by the arrows). By this means it is possible to extinguish the fire which has started.

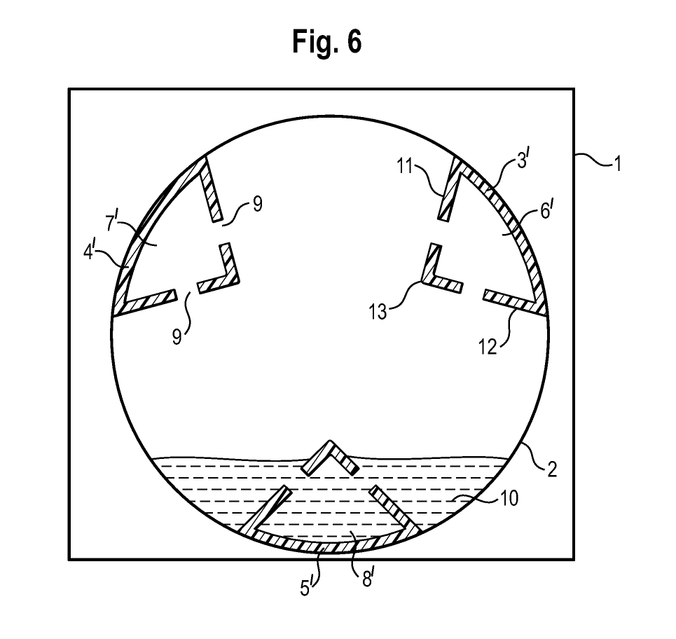

FIG. 6 shows the embodiment from FIG. 5, wherein the drum paddles 3′, 4′, 5′ have emptied and the extinguishing medium 10 is now located on the base of the drum where it smothers the fire.

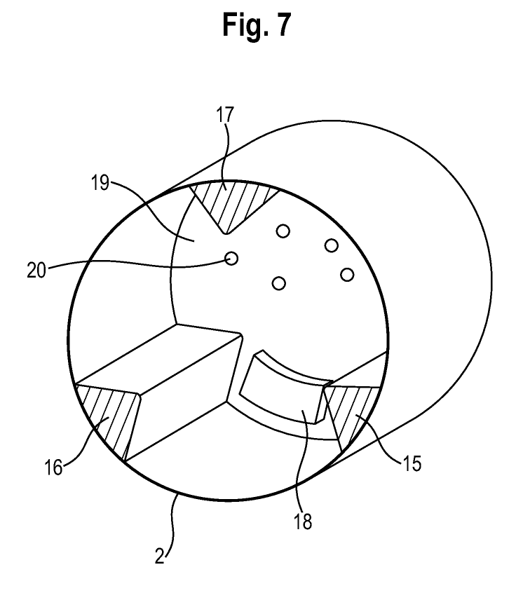

FIG. 7 shows a perspective view of a drum 2 in accordance with another embodiment of the tumble dryer. In this embodiment the paddles 15, 16, 17, have no cavity. However, a container 18 which has a cavity filled with extinguishing agent and also release devices is mounted on the end wall 19 of the drum. The container is preferably mounted such that the holes 20 for feeding the hot air in or out are not covered.

What is claimed is:

1. A tumble dryer, comprising:
a drum having an interior for holding laundry items;
at least one container received in the interior of the drum, said at least one container has a cavity filled with an extinguishing medium; and
at least one release device arranged in a cavity wall of the container for the extinguishing medium, said release device being activated in the event of a fire starting or having started in the drum to thereby provide an opening to the cavity of the container.

2. The tumble dryer of claim 1, constructed in the form of a domestic tumble dryer.

3. The tumble dryer of claim 1, wherein the release device is provided as a sectionwise thinning of the material.

4. The tumble dryer of claim 1, wherein the release device is made from a plastic material which differs from a plastic material of the container.

5. The tumble dryer of claim 1, wherein the container is arranged on or in a radial internal wall of the drum or on one of two end walls of the drum.

6. The tumble dryer of claim 1, wherein the container is a drum paddle.

7. The tumble dryer of claim 1, wherein the release device in the container is a mechanical device which is fully functional independently of a power supply of the tumble dryer.

8. The tumble dryer of claim 1, wherein the release device is made of thin-walled plastic which melts in the event of a fire starting or having started in the drum.

9. The tumble dryer of claim 1, further comprising a plurality of said release device arranged in the container over an entire length of the container.

10. The tumble dryer of claim 1, wherein the release device is sized to extend over an entire length of the container.

11. The tumble dryer of claim 1, further comprising a plurality of said container, each container having a cavity which is filled with an extinguishing medium and having at least one release device for the extinguishing medium.

12. The tumble dryer of claim 1, wherein the extinguishing medium in the cavity of the container is water or extinguishing powder.

13. The tumble dryer of claim 1, wherein the container has at least half a liter of extinguishing medium in the cavity.

14. The tumble dryer of claim 1, wherein the release device is made of polypropylene.

15. The tumble dryer of claim 1, wherein the release device is designed as an elongated slot.

16. The tumble dryer of claim 1, wherein the release device is provided in a side wall in the container designed as a drum paddle and has a circular, punctiform, square, elongated or slot-like configuration.

17. The tumble dryer of claim 1, wherein the release device is constructed to release extinguishing medium without propellant in the drum.
